(19) United States
(12) Patent Application Publication
(10) Pub. No.: US 2025/0301256 A1
(43) Pub. Date: Sep. 25, 2025

(54) Speaker

(71) Applicant: AAC Microtech (Changzhou) Co., Ltd., Changzhou (CN)

(72) Inventors: Weiwei Tao, Changzhou (CN); Xin Jin, Changzhou (CN); Fan Zhang, Changzhou (CN)

(21) Appl. No.: 18/757,372

(22) Filed: Jun. 27, 2024

Related U.S. Application Data
(63) Continuation of application No. PCT/CN2024/082613, filed on Mar. 20, 2024.

(51) Int. Cl. H04R 1/28; H04R 1/02; H04R 7/12; H04R 7/18; H04R 9/02; H04R 9/04; H04R 9/06

(52) U.S. Cl. CPC H04R 1/2811; H04R 1/025; H04R 7/127; H04R 7/18; H04R 9/025; H04R 9/045; H04R 9/06; H04R 2400/07; H04R 2400/11

(57) ABSTRACT

A speaker is disclosed. The speaker includes a shell, a sounding unit and a fixing member. The shell has a sound outlet. The sounding unit includes a vibration member having a rubber diaphragm and a dome. The rubber diaphragm includes an inner suspension, an outer suspension and a main body connecting the two suspensions and covering the dome. The fixing member connects an inner fixing part of the inner suspension and the shell. The dome includes a first side close to the sound outlet and a second side far away from the sound outlet. The main body of the rubber diaphragm at the second side of the dome has a notched part formed by removing rubber of the rubber diaphragm for balancing amplitudes of the first side and the second side. The speaker can reduce the difference in amplitude and improve the acoustic stability without affecting the low frequency.

### FIELD OF THE PRESENT DISCLOSURE

The present disclosure relates to electroacoustic transducers, in particular to a speaker.

### DESCRIPTION OF THE RELATED ART

With the development of science and technology, portable electronic products, such as mobile phones, handheld game consoles, navigation devices and handheld multimedia entertainment devices, are widely used in people's daily life. Since emitting sounds is an essential function of these portable electronic products and the quality of sounds directly affects user's experiences when using these portable electronic products, the requirements for speakers used therein are getting higher and higher.

A speaker in the related art includes a shell having a containing space, and a sounding unit disposed in the containing space and dividing the containing space into a front cavity and a back cavity. One side of the shell is provided with a sound outlet communicating with the front cavity. When a vibration system of the sounding unit vibrates for generating sounds, the large difference in gas flow rate in the front cavity between one position far away from the sound outlet and another position close to the sound outlet is easy to cause a large difference in amplitude between the two positions of the vibration system, as a result, the vibration system vibrates unevenly and the sounds distort.

Thus, it is necessary to provide a novel speaker to solve the problems.

### SUMMARY

An objective of the present disclosure is to overcome the above problems and provide a speaker which can reduce the difference in amplitude and improve the acoustic stability without affecting the low frequency.

In order to achieve the objective mentioned above, the present disclosure discloses a speaker including a shell having a containing space, a sounding unit disposed in the containing space and dividing the containing space into a front cavity and a back cavity, and a fixing member. The shell includes an upper shell and a lower shell engaged with the upper shell. The upper shell is provided with a sound outlet for communicating the front cavity and the outside. The sounding unit includes a frame and a vibration system and a magnetic circuit system that are fixed to the frame. The vibration system includes a vibration member fixed to the frame and a voice coil for driving the vibration member for vibrating and emitting sounds. The vibration member includes a rubber diaphragm and a dome fixed to the rubber diaphragm. The rubber diaphragm includes an inner suspension, an outer suspension and a main body connecting the inner suspension and the outer suspension and covering the dome. The magnetic circuit system includes a bottom plate, a center magnetic member fixed to the bottom plate and a side magnetic member disposed around the center magnetic member for forming a magnetic gap. The inner suspension includes an inner fixing part fixed to the center magnetic member. The fixing member connects the inner fixing part and the upper shell. The dome includes a first side close to the sound outlet and a second side far away from the sound outlet. The first side and the second side are respectively arranged at two opposite sides of the fixing member. The main body of the rubber diaphragm at the second side of the dome is provided with a notched part formed by removing rubber of the rubber diaphragm for balancing amplitudes of the first side and the second side.

As an improvement, the center magnetic member includes a first center magnet, a center yoke, a second center magnet and a third center magnet stacked in sequence from the bottom plate. The inner fixing part has a hollow structure and includes a top wall attached to a top surface of the third center magnet, a side wall extending from the top wall toward the bottom plate and attached to a side surface of the third center magnet, and a bottom wall extending from the side wall and attached to a top surface of the second center magnet.

As an improvement, the vibration system further includes a skeleton connecting the voice coil and the vibration member. The skeleton includes a flat part, a first extension part extending from an outer edge of the flat part toward the bottom plate and a second extension part extending from an inner edge of the flat part toward the bottom plate. The second extension part includes a first portion parallel to a vibration direction of the vibration member and a second portion perpendicular to the first portion. The voice coil is fixed to the second portion and locates in the magnetic gap. The flat part acts as the dome, and the main body of the rubber diaphragm covers the flat part.

As an improvement, the vibration system further includes a flexible support member spaced apart from the vibration member and an auxiliary diaphragm fixed to a side of the flexible support member far away from the vibration member. The flexible support member connects the frame and the first extension part.

As an improvement, an outer edge of the outer suspension is fixed to the frame. The frame, the rubber diaphragm and the skeleton are formed integrally.

As an improvement, the bottom plate is provided with an avoidance groove for avoiding the voice coil. The side magnetic member includes a side magnet fixed to the bottom plate and a side yoke attached to the side magnet, and the side yoke is fixed to the frame.

As an improvement, the speaker further includes a spacer for supporting the sounding unit. The spacer includes a first spacer and a second spacer that are sandwiched between the lower shell and the sounding unit. The first spacer and the second spacer have different thicknesses in a direction from the upper shell to the lower shell.

As an improvement, the notched part is formed by laser removing rubber of the rubber diaphragm.

As an improvement, the lower shell is provided with a leakage hole communicating the back cavity and the outside.

As an improvement, the second center magnet and the third center magnet are integrated.

In the speaker according to the present disclosure, the main body of the rubber diaphragm at the second side of the dome is provided with a notched part formed by removing rubber of the rubber diaphragm, so as to reduce the mass of the second side for balancing the acoustic mass of the first side and the second side, thereby reducing the difference in amplitude and improving the acoustic stability without affecting the low frequency.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art based on the accompanying drawings without creative efforts, wherein:

FIG. 1 is an isometric view of a speaker in accordance with an exemplary embodiment of the present disclosure.

FIG. 2 is an exploded view of the speaker in FIG. 1.

FIG. 3 is a cross-sectional view of the speaker, taken along line A-A in FIG. 1.

FIG. 4 is an enlarged view of part C in FIG. 3.

FIG. 5 is an isometric view of a rubber diaphragm of the speaker in FIG. 1.

FIG. 6 is a cross-sectional view of the speaker, taken along line B-B in FIG. 1.

### REFERENCE NUMBERS

1000: speaker;
1: shell, 10: containing space, 101: front cavity, 102: back cavity, 11: upper shell, 11a: sound outlet, 12: lower shell, 12a: leakage hole;
2: sounding unit, 21: frame, 22: vibration system, 23: magnetic circuit system, 231: bottom plate, 2311: avoidance groove, 232: center magnetic member, 2321: first center magnet, 2322: center yoke, 2323: second center magnet, 2324: third center magnet, 233: magnetic gap, 234: side magnetic member, 2341: side magnet, 2342: side yoke;
3: vibration member, 31: rubber diaphragm, 311: inner suspension, 3111: inner fixing part, 3111a: top wall, 3111b: side wall, 3111c: bottom wall, 312: outer suspension, 313: main body, 3131: notched part, 32: dome, 321: first side, 322: second side;
4: voice coil;
5: fixing member;
6: skeleton, 61: flat part, 62: first extension part, 63: second extension part, 631: first portion, 632: second portion;
7: flexible support member, 8: auxiliary diaphragm;
9: spacer, 91: first spacer, 92: second spacer.

### DETAILED DESCRIPTION OF THE EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

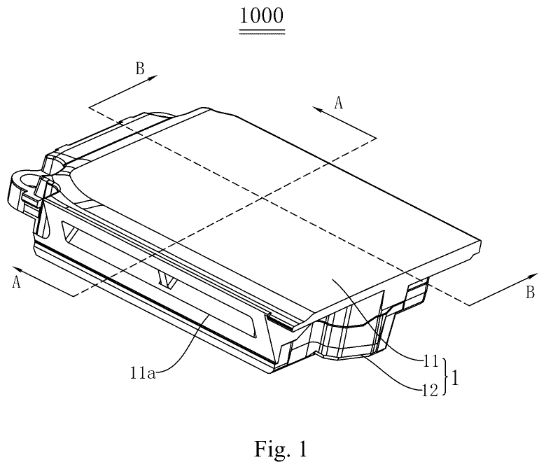

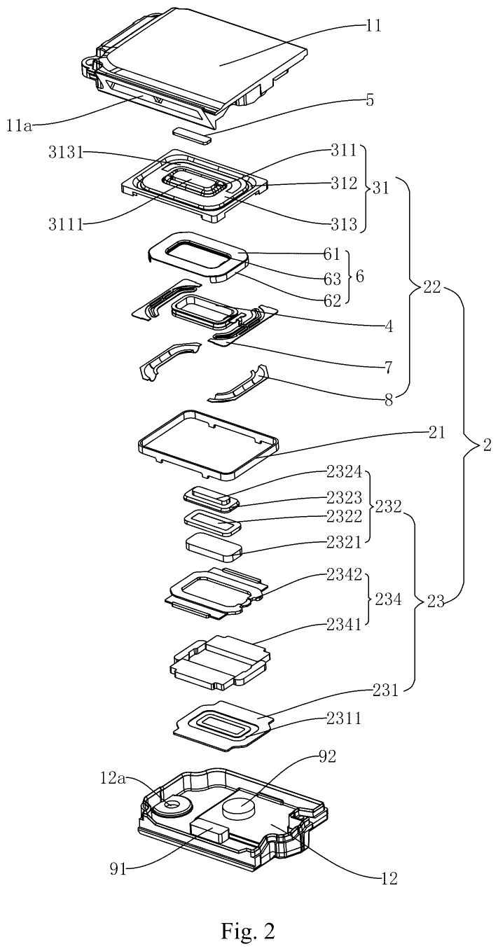

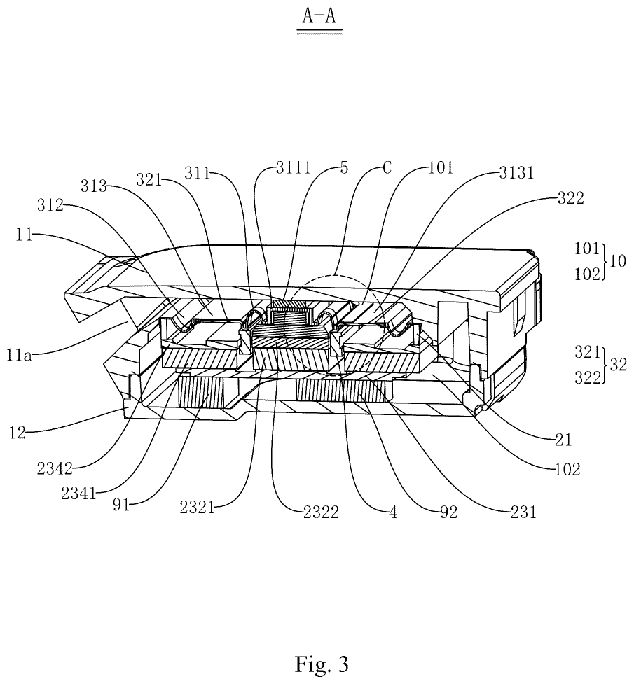

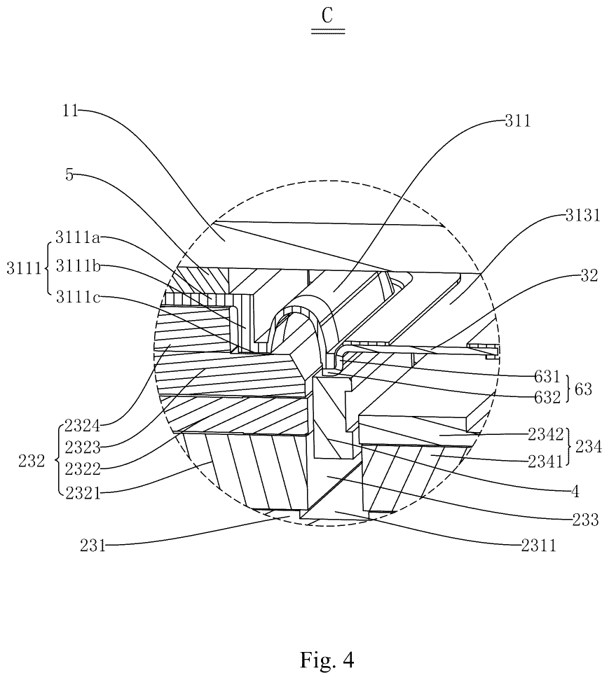

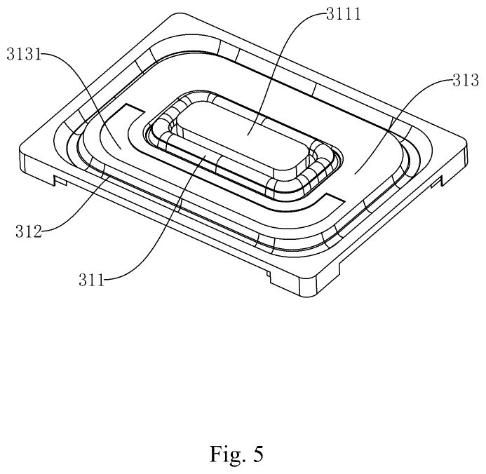

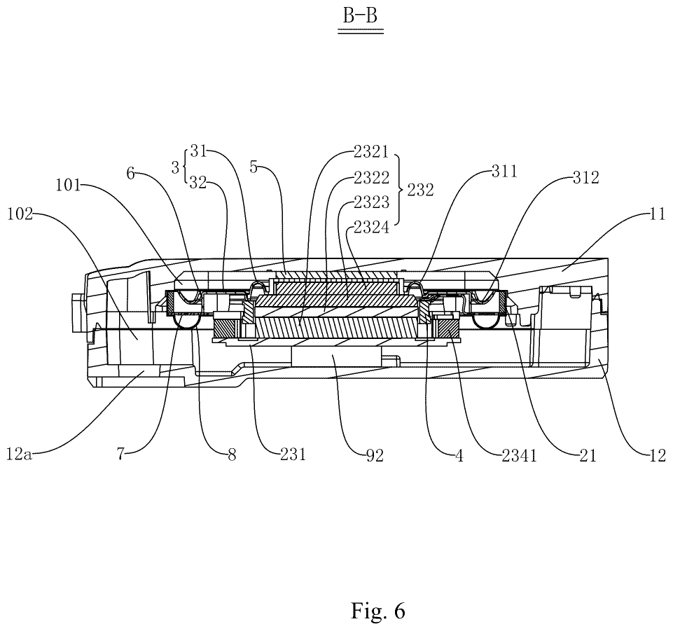

Referring to FIGS. 1-6, the present disclosure discloses a speaker 1000. The speaker 1000 includes a shell 1 having a containing space 10, a sounding unit 2 disposed in the containing space 10 and dividing the containing space 10 into a front cavity 101 and a back cavity 102.

The shell 1 includes an upper shell 11 and a lower shell 12 engaged with the upper shell 11. The upper shell 11 is provided with a sound outlet 11a communicating the front cavity 101 and the outside for transmitting sounds produced by the sounding unit 2 to the outside. The lower shell 12 is provided with a leakage hole 12a communicating the back cavity 102 and the outside for balancing the air pressure.

The sounding unit 2 includes a frame 21 and a vibration system 22 and a magnetic circuit system 23 that are fixed to the frame 21.

The vibration system 22 includes a vibration member 3 fixed to the frame 21 and a voice coil 4 for driving the vibration member 3 for vibrating and emitting sounds. The vibration member 3 includes a rubber diaphragm 31 and a dome 32 fixed to the rubber diaphragm 31. The rubber diaphragm 31 includes an inner suspension 311, an outer suspension 312 and a main body 313 connecting the inner suspension 311 and the outer suspension 312 and covering the dome 32. The magnetic circuit system 23 includes a bottom plate 231, a center magnetic member 232 fixed to the bottom plate 231 and a side magnetic member 234 disposed around the center magnetic member 232 for forming a magnetic gap 233. The inner suspension 311 includes an inner fixing part 3111 fixed to the center magnetic member 232. An outer edge of the outer suspension 312 is fixed to the frame 21. The speaker 1000 further includes a fixing member 5 connecting the inner fixing part 3111 and the upper shell 11. The dome 32 includes a first side 321 close to the sound outlet 11a and a second side 322 far away from the sound outlet 11a. The first side 321 and the second side 322 are respectively arranged at two opposite sides of the fixing member 5. The main body 313 of the rubber diaphragm 31 at the second side 322 of the dome 32 is provided with a notched part 3131 formed by removing rubber of the rubber diaphragm 31 for balancing amplitudes of the first side 321 and the second side 322.

It should be noted that, the thickness of the rubber diaphragm 31 and the shape and size of the notched part 3131 can be adjusted according to the actual situation. The manner in which the notched part 3131 is formed is not limited herein. Optionally, in this embodiment, the notched part 3131 is formed by laser removing rubber of the rubber diaphragm 31. The notched part 3131 can be dynamically formed according to different sound outlet positions, so as to easily match shells having different sound outlet positions.

The vibration system 22 further includes a skeleton 6 connecting the voice coil 4 and the vibration member 3. The frame 21, the rubber diaphragm 31 and the skeleton 6 can be formed integrally.

The skeleton 6 includes a flat part 61, a first extension part 62 extending from an outer edge of the flat part 61 toward the bottom plate 231 and a second extension part 63 extending from an inner edge of the flat part 61 toward the bottom plate 231. The second extension part 63 includes a first portion 631 parallel to a vibration direction of the vibration member 3 and a second portion 632 perpendicular to the first portion 631. The voice coil 4 is fixed to the second portion 632 and locates in the magnetic gap 233. The flat part 61 acts as the dome 32, and the main body 313 of the rubber diaphragm 31 covers the flat part 61.

The vibration system 22 further includes a flexible support member 7 spaced apart from the vibration member 3 and an auxiliary diaphragm 8 fixed to a side of the flexible support member 7 far away from the vibration member 3. The flexible support member 7 connects the frame 21 and the first extension part 62. The auxiliary diaphragm 8 can improve the low frequency of the speaker 1000. The voice coil 4 electrically connects with the flexible support member 7.

The bottom plate 231 is provided with an avoidance groove 2311 for avoiding the voice coil 4. The center magnetic member 232 includes a first center magnet 2321, a center yoke 2322, a second center magnet 2323 and a third center magnet 2324 stacked in sequence from the bottom plate 231. The second center magnet 2323 and the third center magnet 2324 can be integrated, or combined together. The side magnetic member 234 includes a side magnet 2341 fixed to the bottom plate 231 and a side yoke 2342 attached to the side magnet 2341, and the side yoke 2342 is fixed to the frame 21.

The inner fixing part 3111 has a hollow structure and includes a top wall 3111a attached to a top surface of the third center magnet 2324, a side wall 3111b extending from the top wall 3111a toward the bottom plate 231 and attached to a side surface of the third center magnet 2324, and a bottom wall 3111c extending from the side wall 3111b and attached to a top surface of the second center magnet 2323.

The speaker 1000 further includes a spacer 9 for supporting the sounding unit 2. The spacer 9 includes a first spacer 91 and a second spacer 92 that are sandwiched between the lower shell 12 and the sounding unit 2. The spacer 9 can make the sounding unit 2 locate in the containing space 10 firmly. The first spacer 91 and the second spacer 92 have different thicknesses in a direction from the upper shell 11 to the lower shell 12, so as to easily match shells having different shapes and sizes. In this embodiment, the thickness of the first spacer 91 is greater than that of the second spacer 92.

In the speaker 1000 according to the present disclosure, the main body 313 of the rubber diaphragm 31 at the second side 322 of the dome 32 is provided with a notched part 3131 formed by removing rubber of the rubber diaphragm 31, so as to reduce the mass of the second side 322 for balancing the acoustic mass of the first side 321 and the second side 322, thereby reducing the difference in amplitude and improving the acoustic stability without affecting the low frequency.

The above are only embodiments of the present disclosure. It should be pointed out that those of ordinary skill in the art may also make improvements without departing from the ideas of the present disclosure, all of which fall within the protection scope of the present disclosure.

What is claimed is:

1. A speaker, comprising:
a shell having a containing space;
a sounding unit disposed in the containing space and dividing the containing space into a front cavity and a back cavity; and
a fixing member,
wherein the shell comprises an upper shell and a lower shell engaged with the upper shell; the upper shell is provided with a sound outlet for communicating the front cavity and the outside; the sounding unit comprises a frame and a vibration system and a magnetic circuit system that are fixed to the frame; the vibration system comprises a vibration member fixed to the frame and a voice coil for driving the vibration member for vibrating and emitting sounds; the vibration member comprises a rubber diaphragm and a dome fixed to the rubber diaphragm; the rubber diaphragm comprises an inner suspension, an outer suspension and a main body connecting the inner suspension and the outer suspension and covering the dome; the magnetic circuit system comprises a bottom plate, a center magnetic member fixed to the bottom plate and a side magnetic member disposed around the center magnetic member for forming a magnetic gap; the inner suspension comprises an inner fixing part fixed to the center magnetic member; the fixing member connects the inner fixing part and the upper shell; the dome comprises a first side close to the sound outlet and a second side far away from the sound outlet; the first side and the second side are respectively arranged at two opposite sides of the fixing member; the main body of the rubber diaphragm at the second side of the dome is provided with a notched part formed by removing rubber of the rubber diaphragm for balancing amplitudes of the first side and the second side.

2. The speaker as described in claim 1, wherein the center magnetic member comprises a first center magnet, a center yoke, a second center magnet and a third center magnet stacked in sequence from the bottom plate; the inner fixing part has a hollow structure and comprises a top wall attached to a top surface of the third center magnet, a side wall extending from the top wall toward the bottom plate and attached to a side surface of the third center magnet, and a bottom wall extending from the side wall and attached to a top surface of the second center magnet.

3. The speaker as described in claim 1, wherein the vibration system further comprises a skeleton connecting the voice coil and the vibration member; the skeleton comprises a flat part, a first extension part extending from an outer edge of the flat part toward the bottom plate and a second extension part extending from an inner edge of the flat part toward the bottom plate; the second extension part comprises a first portion parallel to a vibration direction of the vibration member and a second portion perpendicular to the first portion; the voice coil is fixed to the second portion and locates in the magnetic gap; the flat part acts as the dome, and the main body of the rubber diaphragm covers the flat part.

4. The speaker as described in claim 3, wherein the vibration system further comprises a flexible support member spaced apart from the vibration member and an auxiliary diaphragm fixed to a side of the flexible support member far away from the vibration member; the flexible support member connects the frame and the first extension part.

5. The speaker as described in claim 3, wherein an outer edge of the outer suspension is fixed to the frame; the frame, the rubber diaphragm and the skeleton are formed integrally.

6. The speaker as described in claim 1, wherein the bottom plate is provided with an avoidance groove for avoiding the voice coil; the side magnetic member comprises a side magnet fixed to the bottom plate and a side yoke attached to the side magnet, and the side yoke is fixed to the frame.

7. The speaker as described in claim 1, further comprising a spacer for supporting the sounding unit, wherein the spacer comprises a first spacer and a second spacer that are sandwiched between the lower shell and the sounding unit, the first spacer and the second spacer have different thicknesses in a direction from the upper shell to the lower shell.

8. The speaker as described in claim 1, wherein the notched part is formed by laser removing rubber of the rubber diaphragm.

9. The speaker as described in claim 1, wherein the lower shell is provided with a leakage hole communicating the back cavity and the outside.

10. The speaker as described in claim 2, wherein the second center magnet and the third center magnet are integrated.
